(19) United States
(12) Patent Application Publication
(10) Pub. No.: US 2011/0293393 A1
(43) Pub. Date: Dec. 1, 2011

(54) HAY BALE TRANSPORT DEVICE

(76) Inventor: Roy Nuxoll, Cottonwood, ID (US)

(21) Appl. No.: 12/789,165

(22) Filed: May 27, 2010

(51) Int. Cl. B60R 9/06

(52) U.S. Cl. 414/462

(57) ABSTRACT

A hay bale transport device comprising a frame attached to a vehicle, a tower fastened on a pivot to the frame, a large hydraulic cylinder attached to both the tower and the frame, and a tower conveyor along the tower, with a side discharge conveyor at an opposite end of the tower to the pivot. The tower may have a plurality of spears inside a plurality of small hydraulic cylinders which are attached to the tower at the pivot. The plurality of spears engage at least one hay bale to the tower when the tower is in a vertical position, the large hydraulic cylinder lowers the tower to a horizontal position onto the frame, the tower conveyor rolls the hay bale onto the side discharge conveyor and finally the side discharge conveyor rolls the hay bale off of the vehicle bed. The present invention saves a cattle owner time and money by enabling a single operator with their truck to load, carry and unload a stack of hay bales.

### BACKGROUND OF THE INVENTION

1. Field of the Invention

The present invention relates to a transport device for a vehicle which may lift and carry hay bales from one location to another.

2. Description of Related Art

The livelihood of many families and individuals relies on the raising and selling of cattle animals. Much time is spent feeding the cattle by transporting hay bales to from the barn shed to various feeders on their land. The hay bales can be large and very heavy; too heavy for a person to lift and carry. Normally, a diesel-powered tractor is used to load the hay bale onto a truck bed. The tractor then follows the truck to the feeding location and unloads the hay bales. This process can be very time consuming and expensive for the cattle owners because two vehicles are used to carry out the task along with two handlers who drive and operate the vehicles. Also, since the tractors are usually diesel powered, petroleum costs and vehicle maintenance add further expenses to the feeding task.

It would be beneficial to have a device that may be used to load and unload hay bales onto a truck without requiring the tractor and thus eliminating the need for additional vehicle. Also, it would be desirable to have a device which can be operated by a single person when feeding the cattle animals.

### SUMMARY OF THE INVENTION

The present invention provides an improved way to transfer bales of hay to feed ranch cattle. The hay bale transport device may be used to load, transport and unload hay bales from a holding barn to the feeding locations. The device may be operated by a single person controlling a set of hydraulic motors from the cab of his vehicle. The present invention may be operated by loading one or more hay bales onto a tower in a vertical position with a plurality of spears. The tower may lower to a horizontal position that sets the hay bales onto a frame, where the frame is attached to the vehicle for transport. The hay bale transport device has two conveyors which slide the hay bales first along the tower to a side discharge unit, which then unloads the hay bales off the side of the vehicle bed. Since only one person is required to operate the device and a tractor is unnecessary, the cattle rancher saves time and money thus increasing their productivity and maximizing their financial resources.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 is a side view of a hay bale transport device, in accordance with an exemplary embodiment of the present invention;

FIG. 2 is a perspective view of a hay bale transport device, in accordance with an exemplary embodiment of the present invention;

FIG. 3 is a perspective view of a frame of a hay bale transport device, in accordance with an exemplary embodiment of the present invention;

FIG. 4 is a side view of a hay bale transport device with the tower extended vertically, in accordance with an exemplary embodiment of the present invention;

FIG. 5 is a top view of a hay bale transport device, in accordance with an exemplary embodiment of the present invention;

FIG. 6 is a rear view of a side discharge unit and tower, in accordance with an exemplary embodiment of the present invention; and

FIG. 7 is an enlarged view of an underside of a hay bale transport device, in accordance with an exemplary embodiment of the present invention.

Like reference numerals refer to like parts throughout the description of several views of the drawings.

### DETAILED DESCRIPTION

The present invention enables for easy transport of hay bales for feeding cattle animals, by allowing a single person using a single vehicle to both collect and deliver multiple hay bales. After loading the hay bales and reaching the feeding location, an operator uses the hay bale transport device to unload the hay bales off the side of the vehicle bed using a hydraulically powered conveyor. The present invention may alleviate using a diesel tractor to move the hay bales and provides a less costly and more energy efficient method of transporting hay bales.

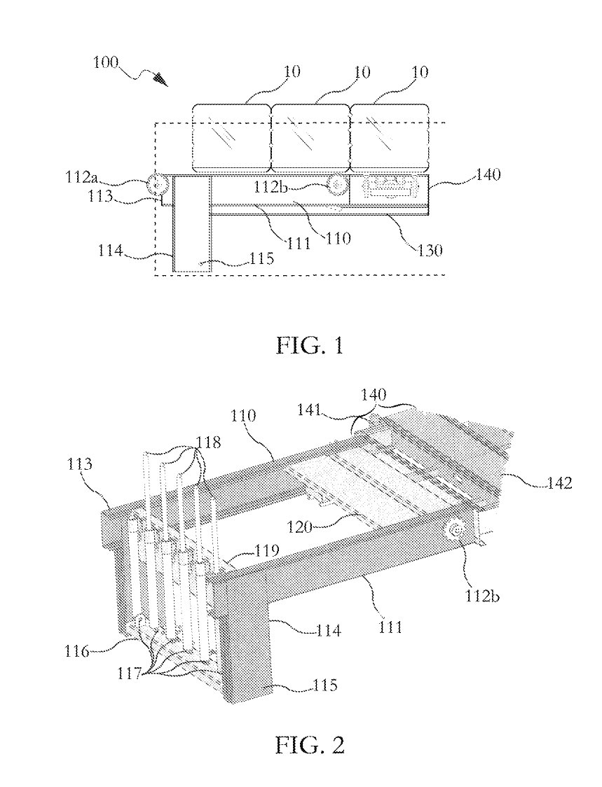

Now turning descriptively to the drawings, FIG. 1 is a side view of a hay bale transport device (100), in accordance with the present invention. The hay bale transport device (100) may comprise a tower (110), a frame (130) and a side discharge unit (140). The tower (110), shown in a horizontal position, may have a tower arm (111), a foot (113), a tower base (114) and a tower pivot (115) to move a plurality of hay bales (10) (hereinafter referred to as hay bales). The hay bale transport (100) may be supported at a first end by the tower base (114) and at a second end by a vehicle bed (not shown). The frame (130) may attach to the vehicle bed for stability when loading the hay bales (10). The vehicle may be a truck, a trailer or any other vehicle which can carry the weight of the hay bales.

The hay bale transport device (100) may have two drag chains conveyors. A tower conveyor to guide the hay along the tower arm (111), and a side discharge conveyor to slide the hay bale off the side of the vehicle bed. Both may be run by hydraulic motors. The tower conveyor may have a first wheel (112a) at a first end of the tower (110) next to the tower base (114), and a second wheel (112b) at a second end of the tower (110). The tower conveyor may advance the hay bales (10) onto the side discharge unit (140). The side discharge conveyor may unload the hay bale (10) off the side of the pickup.

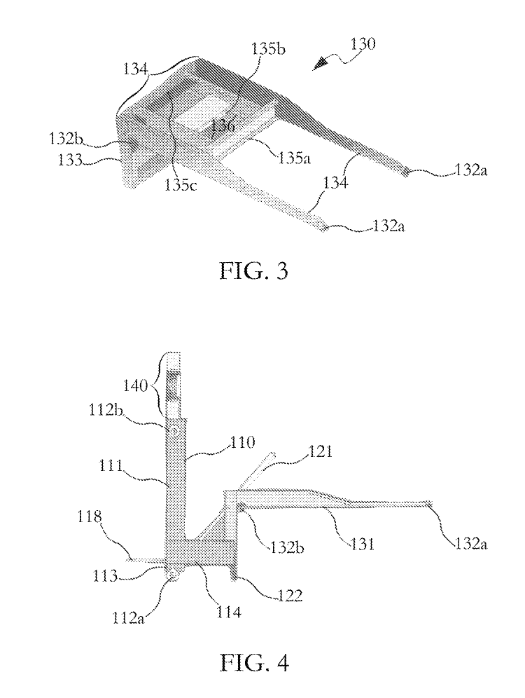

Referring to FIG. 2, a perspective view of the hay bale transport device (100) is shown to illustrate the tower (110) and the side discharge unit (140). The tower (110) may additionally comprise a base (116), a plurality of hydraulic cylinders (117) (hereinafter hydraulic cylinders), a plurality of spears (118) (hereinafter spears), presently shown in an extended position, and a beam (119). The hydraulic cylinders (117) may be mounted to the base (116) at a first end, and at a second end attached to the beam (119). The hydraulic cylinders (117) may house the spears (118), which may extend and retract within the hydraulic cylinders (117).

The tower conveyor may comprise the wheel (112b) and additionally a set of slats (120) (herein after slats), a set of cables (not shown) and a hydraulic motor (not shown). The hay bales may rest on the slats (120) while on the tower (110). The tower conveyor may slide the hay bales onto the side discharge unit (140). The side discharge unit (140) may comprise a conveyor wheel (141), a side discharge conveyor (142) and a hydraulic motor (not shown). The hydraulic motor may enable the movement of the conveyor wheel (141), thus moving the side discharge conveyor (142). After the tower conveyor slides the hay bales onto the side discharge unit (140), the side discharge conveyor (142) moves the hay bale off of the hay bale transport device (100).

Referring to FIG. 3, a perspective view of a frame (130) is shown in accordance with an exemplary embodiment of the present invention. The frame (130) may have a set of arms (131) (hereinafter arms), a plurality of attachment means (132a, 132b) (hereinafter attachment means), a leg (133) and a support housing (134). The attachment means (132a, 132b) may fasten the arms (131) to the vehicle bed to ensure that the frame (130) does not shift or slide while the hay bale transport device is operating. The attachment means (132a, 132b) may be a bolt, pin or other fastening device used or known in the art. The support housing (134) may comprise a plurality of horizontal beams (135a, 135b, 135c) (horizontal beams) and a set of lateral beams (136) (hereinafter lateral beam). The frame (130) may give strength and stability to the hay bale transport structure especially when loading the hay bales.

Referring to FIG. 4, a side view of the hay bale transport device (100) is shown with the tower (110) extended vertically. The tower (110) may extend the spears (118) into a stack of one, two or three hay bales (not shown). The hay bales may be supported against the tower arms (111) while engaged on the spears (118). A large hydraulic cylinder (121) may lower the tower from a vertical position (as presently shown) to a horizontal position (as shown in FIG. 1). The tower (110) may rotate from the base (114), around a pivot (115) when switching from the horizontal position to the vertical position. After the spears (118) have engaged the hay bales, the tower (110) may load the hay bales onto the hay bale transport device by rotating around the pivot (115) into the horizontal position. Since the tower (110) rotates around the pivot (115), a rolling action may take place rather than a lifting action, which requires less effort from the large hydraulic cylinder (121). The foot (113) may be used as a rest or a support for when the tower is in the vertical position. A support bar (123) may extend from the frame (130) to give additional strength to the foot (113) when loading the hay bales.

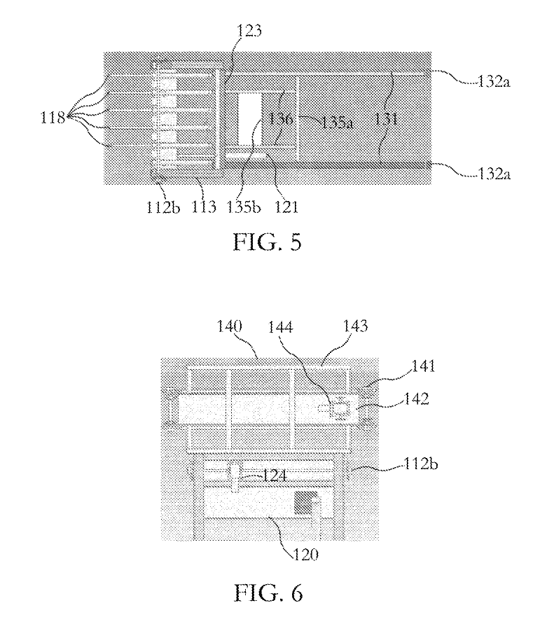

Referring to FIG. 5, a top view of the hay bale transport device is shown with the tower in the vertical position, in accordance with an exemplary embodiment of the present invention. For simplicity in viewing, the side discharge unit is not shown. A cross bar (123) may be fastened between the arms (131) to reinforce the strength of the frame. The large hydraulic cylinder (121) may be mounted on the cross bar (123) allow the tower move from the horizontal position to the vertical position.

Referring to FIG. 6, a backside view of the side discharge unit and the tower arm is shown while the tower is in the vertical position. The perspective may be from the cab of the vehicle or vehicle bed. FIG. 6 shows how the side discharge unit (140) may be situated on the tower. A hydraulic motor (124, 144) may be mounted under the tower conveyor and the side discharge conveyor (142). The hydraulic motors (124,144) may activate the conveyors when sliding the hay bales first along the tower arm and then off the side of the vehicle bed.

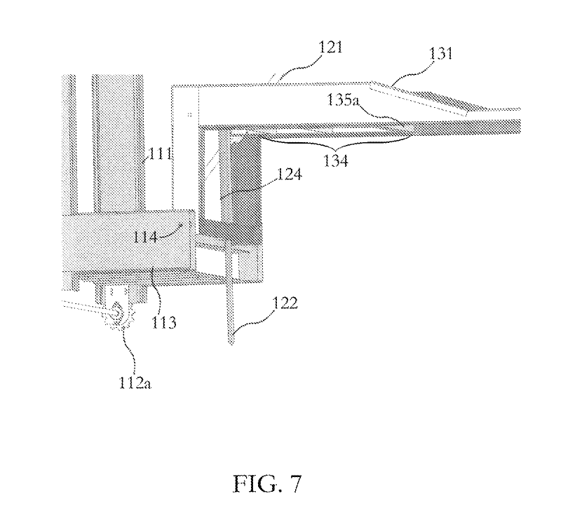

Referring to FIG. 7, a view from the underside of the hay bale transport device is shown in accordance with an exemplary embodiment of the present invention. The support bar (122) may attach to the bottom of frame (130) and extends to the ground when loading the hay bales. The support bar (122) may support the back of the vehicle bed when bales are first lifted. As the bales are rolled along the tower (110) towards the side discharge unit the weight is evenly distributed on the vehicle bed. Once the tower is in the horizontal position, the support bar (122) may be retracted.

The hay bale transport device may be operated by a hydraulic pump mounted to the transmission of the vehicle. A plurality solenoid valves (hereinafter valves) may control the plurality of hydraulic cylinders, the large hydraulic cylinder and the hydraulic motors. The valves may be a 12-volt valve or another type of valve that may handle operating the transport device. The operator may have a hand held pendant with eight buttons to activate the valves. The hand held pendant may ease the operator's physical work to merely driving the vehicle and cutting a twine string on the hay bale for feeding. Overall, the present invention may save time and money to allow a single person to load, carry and unload one or more hay bales with a single vehicle.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching.

What is claimed is:

1. A hay bale transport device for assisting in transporting of hay comprising:
a frame attached to a vehicle;
a tower fastened on a pivot to the frame, where said tower has a vertical position and a horizontal position;
a large hydraulic cylinder attached to both the tower and the frame;
a tower conveyor along the tower;
a side discharge conveyor at an opposite end of the tower to the pivot; and
a plurality of spears inside a plurality of small hydraulic cylinders attached to the tower at the pivot, wherein the plurality of spears engage at least one a hay bale to the tower when the tower is in the vertical position, the large hydraulic cylinder lowers the tower to the horizontal position onto the frame, the tower conveyor rolls the hay bale onto the side discharge conveyor and the side discharge conveyor rolls the hay bale off of the vehicle.

2. The hay bale transport device according to claim 1, wherein the vehicle may be a truck or a trailer.

3. The hay bale transport device according to claim 1, wherein the frame may have a support bar which lowers when the tower is in the vertical position to help support the tower when lifting the hay bales.

4. The hay bale transport device according to claim 1, wherein the plurality of spears may extend and retract within the plurality of hydraulic cylinders.

5. The hay bale transport device according to claim 1, wherein the tower conveyor and the side discharge conveyor are each a drag chain conveyor.

6. The hay bale transport device according to claim 5, wherein the drag chain conveyors comprise a set of slats to move the hay bales.

7. The hay bale transport device according to claim 5, wherein the drag chain conveyor is powered by a motor.

8. The hay bale transport device according to claim 1, wherein the frame has a plurality of attachment means to fasten the frame to the vehicle bed.
